(19) United States
(12) Patent Application Publication
(10) Pub. No.: US 2024/0377926 A1
(43) Pub. Date: Nov. 14, 2024

(54) ELECTRONIC APPARATUS CAPABLE OF SIMULTANEOUSLY DISPLAYING, ON ONE SCREEN, PAGES CONSTITUTING ELECTRONIC DOCUMENT BY TWO PAGES, EACH AND OPERATING METHOD THEREFOR

(71) Applicant: FLEXCIL INC., Seongnam-si, Gyeonggi-do (KR)

(72) Inventors: Chae Myeong LIM, Seongnam-si, Gyeonggi-do (KR); Ji Hoon PARK, Seongnam-si, Gyeonggi-do (KR)

(73) Assignee: FLEXCIL INC., Seongnam-si, Gyeonggi-do (KR)

(21) Appl. No.: 18/577,279

(22) PCT Filed: Jul. 22, 2022
(86) PCT No.: PCT/KR2022/010763

§ 371 Date: Jan. 8, 2024

(30) Foreign Application Priority Data
Jul. 26, 2021 (KR) 10-2021-0097513

(51) Int. Cl. G06F 3/0483

(52) U.S. Cl. CPC G06F 3/0483; G06F 2203/04803

(57) ABSTRACT

Disclosed are an electronic apparatus and an operating method thereof. The present invention relates to an electronic apparatus capable of displaying the page that constitutes an electronic document by two pages at the same time on one screen and an operating method thereof.

### TECHNICAL FIELD

The present invention relates to an electronic apparatus capable of displaying the page that constitutes an electronic document by two pages at the same time on one screen and an operating method thereof.

### Background Art

In recent years, as a computer, a smart phone, a tablet PC, or the like have widely propagated, various types of electronic document related programs have been released, which enable reading, preparing, and editing the electronic document by using the electronic apparatus.

Existing electronic document-related programs often display only one page on one screen when displaying an electronic document consisting of multiple pages.

In this regard, when a paper book is usually opened, two pages are shown to a user at one time, so from the perspective of a user who enjoys paper books, even when viewing the electronic document, it may be preferred that two pages are shown on one screen at a time like the paper book.

In addition, when two pages are displayed at one time on one screen, the convenience of the user reading the electronic document may be enhanced in that user can understand various information at a glance.

Therefore, research is needed on technology that can display the page constituting the electronic document by two pages at the same time on one screen, like when the paper book is opened.

However, in the case of the electronic document, there may be cases where the pages that constitute the electronic document have all the same size, but in some cases, the pages that constitute the electronic document may have different sizes, so the pages that constitute the electronic document may have different sizes, in order to display two pages of the electronic document constituted by pages having different sizes at the same time on one screen, the size of each page is appropriately adjusted by considering the size of each page, so an entire region of the page should be processed to be included and displayed in each display region in which two pages are to be displayed.

Therefore, technology also needs to be introduced jointly which adjusts the page to be displayed at an appropriate size in the display region by considering the size of each page when displaying the page constituting the electronic document by two pages at the same time on one screen.

### Disclosure

### Technical Problem

The present invention has been made in an effort to provide an electronic apparatus capable of displaying the page that constitutes an electronic document by two pages at the same time on one screen and an operating method thereof to support improved page display of the electronic document to be enabled.

### Technical Solution

An embodiment of the present invention provides an electronic apparatus capable of displaying the page that constitutes an electronic document by two pages at the same time on one screen, which includes: a document display event generation unit generating, when a document display instruction instructing two pages of an electronic document pre-constituted by k (k is a natural number of 3 or more) pages to be displayed at the same time on one screen is applied from the user, a document display event for displaying the k pages by two pages at the same time on one screen; a horizontal length confirmation unit confirming, when the document display event is generated, a horizontal length of each of the k pages by confirming page size information predetermined for each of the k pages; a page selection unit selecting the first page with a maximum horizontal length among the k pages; a region split unit splitting, when the first page is selected, a display region in which a document is displayed on a screen of the electronic apparatus into a left region and a right region based on a vertical axis passing through a center point of the display region; a first scale value calculation unit confirming, when the display region is split into the left region and the right region, a horizontal length of the left region, and then calculating a first scale value for a case of performing size adjustment of the first page so that the horizontal length of the first page is equal to the horizontal length of the left region; a size adjustment unit adjusting a size of each of the k pages according to the first scale value when the first scale value is calculated; and a document display unit displaying an n (n is a natural number)-th page among the k pages at the left region, and simultaneously displays an n+1-th page at the right region when the size of each of the k pages is adjusted.

Further, another exemplary embodiment of the present invention provides an operating method of an electronic apparatus capable of displaying the page that constitutes an electronic document by two pages at the same time on one screen, which includes: generating, when a document display instruction instructing two pages of an electronic document pre-constituted by k (k is a natural number of 3 or more) pages to be displayed at the same time on one screen is applied from the user, a document display event for displaying the k pages by two pages at the same time on one screen; confirming, when the document display event is generated, a horizontal length of each of the k pages by confirming page size information predetermined for each of the k pages; selecting the first page with a maximum horizontal length among the k pages; splitting when the first page is selected, a display region in which a document is displayed on a screen of the electronic apparatus into a left region and a right region based on a vertical axis passing through a center point of the display region; confirming, when the display region is split into the left region and the right region, a horizontal length of the left region, and then calculating a first scale value for a case of performing size adjustment of the first page so that the horizontal length of the first page is equal to the horizontal length of the left region; adjusting a size of each of the k pages according to the first scale value when the first scale value is calculated; and displaying an n (n is a natural number)-th page among the k pages at the left region, and simultaneously displaying an n+1-th page at the right region when the size of each of the k pages is adjusted.

### Advantageous Effects

According to an embodiment of the present invention, an electronic apparatus capable of displaying the page that constitutes an electronic document by two pages at the same time on one screen and an operating method thereof are provided to support improved page display of the electronic document to be enabled.

### DESCRIPTION OF DRAWINGS

FIG. 1 is a diagram illustrating a structure of an electronic apparatus capable of displaying the page that constitutes an electronic document by two pages at the same time on one screen according to an embodiment of the present invention.

FIGS. 2 to 5 are diagrams for describing an operation of an electronic apparatus capable of displaying the page that constitutes an electronic document by two pages at the same time on one screen according to an embodiment of the present invention.

FIG. 6 is a flowchart illustrating an operating method of an electronic apparatus capable of displaying the page that constitutes an electronic document by two pages at the same time on one screen according to an embodiment of the present invention.

### BEST MODE

Hereinafter, exemplary embodiments of the present invention will be described in detail with reference to the accompanying drawings. The description does not limit the present invention to specific exemplary embodiments, and it should be understood that the present invention covers all the modifications, equivalents and replacements included within the idea and technical scope of the present invention. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present invention, each of components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning compute program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

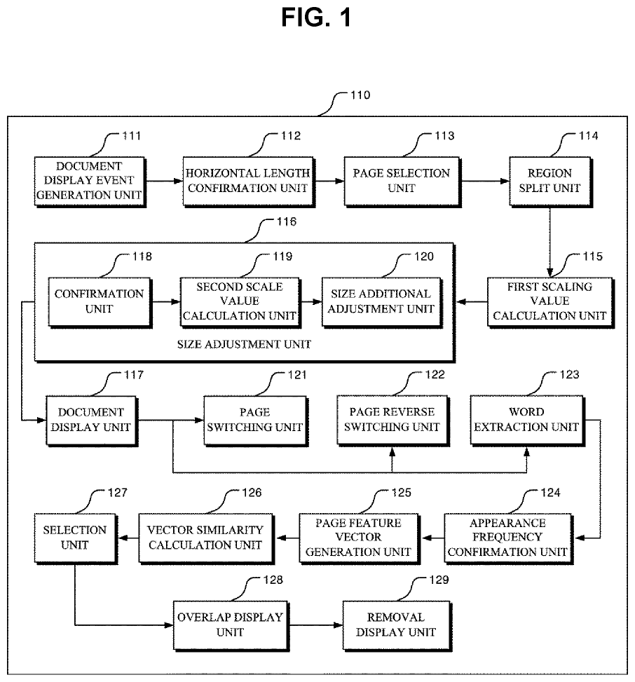

FIG. 1 is a diagram illustrating a structure of an electronic apparatus capable of displaying the page that constitutes an electronic document by two pages at the same time on one screen according to an embodiment of the present invention.

Referring to FIG. 1, the electronic apparatus 110 according to an embodiment of the present invention includes a document display event generation unit 111, a horizontal length confirmation unit 112, a page selection unit 113, a region split unit 114, a first scale value calculation unit 115, a size adjustment unit 116, and a document display unit 117.

When a document display instruction instructing two pages of an electronic document pre-constituted by k (k is a natural number of 3 or more) pages to be displayed at the same time on one screen is applied from the user, the document display event generation unit 111 generates a document display event for displaying the k pages by two pages at the same time on one screen.

Here, page sizes of the k pages may have different sizes. For example, a first page may have a page size of a A4 format editing paper size, and a second page may have a page size of a B4 format editing paper size.

When the document display event is generated, the horizontal length confirmation unit 112 confirms a horizontal length of each of the k pages by confirming page size information predetermined for each of the k pages.

The page selection unit 113 selects the first page with a maximum horizontal length among the k pages.

When the first page is selected, the region split unit 114 splits a display region in which a document is displayed on a screen of the electronic apparatus 110 into a left region and a right region based on a vertical axis passing through a center point of the display region.

When the display region is split into the left region and the right region, the first scale value calculation unit 115 confirms a horizontal length of the left region, and then calculates a first scale value for a case of performing size adjustment of the first page so that the horizontal length of the first page is equal to the horizontal length of the left region.

The size adjustment unit 116 adjusts a size of each of the k pages according to the first scale value when the first scale value is calculated.

The document display unit 117 displays an n (n is a natural number)-th page among the k pages at the left region, and simultaneously displays an n+1-th page at the right region when the size of each of the k pages is adjusted.

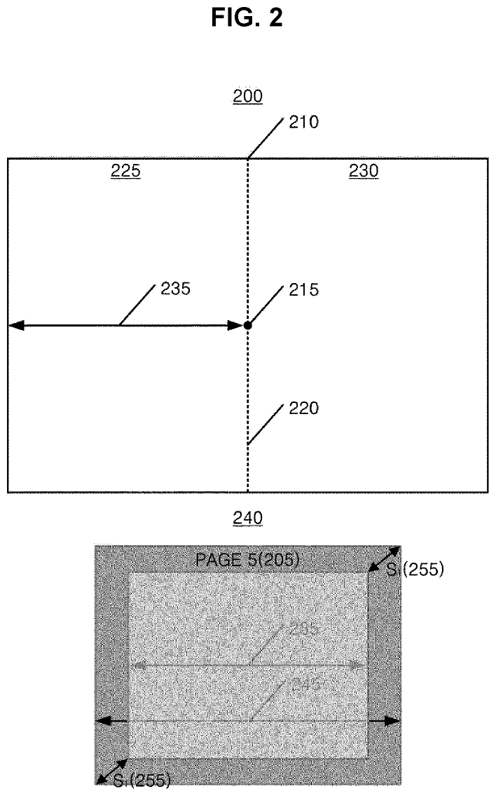

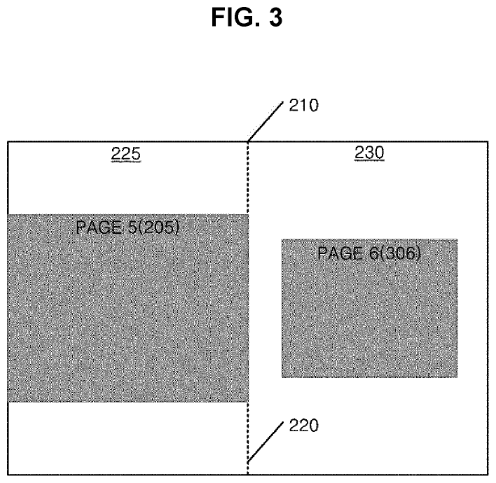

Hereinafter, referring to FIGS. 2 to 3, operations of the document display event generation unit 111, the horizontal length confirmation unit 112, the page selection unit 113, the region split unit 114, the first scale value calculation unit 115, the size adjustment unit 116, and the document display unit 117 will be described in detail as an example.

First, it is assumed that ‘k=10’ and that the electronic document is pre-constituted by 10 pages, ‘Page 1, Page 2, Page 3, . . . , Page 10’.

At this time, when a document display instruction instructing the electronic document pre-constituted by 10 pages, ‘Page 1, Page 2, Page 3, . . . , Page 10’ to be displayed by two pages at the same time on one screen is applied to the electronic apparatus 110 from the user, the document display event generation unit 111 may generate a document display event for displaying ‘Page 1, Page 2, Page 3, . . . , Page 10’ which are 10 pages by two pages at the same time on one screen.

In this way, when the document display event is generated by the document display event generation unit 111, the horizontal length confirmation unit 112 confirms page size information predetermined for each of ‘Page 1, Page 2, Page 3, . . . , Page 10’ to confirm a horizontal length of each of ‘Page 1, Page 2, Page 3, . . . , Page 10″.

Afterwards, the page selection unit 113 may select the first page with the maximum horizontal length among ‘page 1, page 2, page 3, . . . , page 10’.

Assuming that ‘Page 5 205’ is selected as the first page with the maximum horizontal length among ‘Page 1, Page 2, Page 3, . . . , Page 10’ by the page selection unit 113, the region split unit 114 may split a display region 210 in which a document is displayed on the screen of the electronic apparatus 110 into a left region 225 and a right region 230 based on a vertical axis 220 passing through a center point 215 of the display region 210 as in a diagram illustrated by reference numeral 200 of FIG. 2.

In this way, when the display region 210 is split into the left region 225 and the right region 230 by the region split unit 114, the first scale value calculation unit 115 may confirm a horizontal length 235 of the left region 225 as in the drawing illustrated by reference numeral 200 of FIG. 2.

Thereafter, the first scale value calculation unit 115 may calculate, as ‘S₁ 255’, a first scale value for a case of performing size adjustment of ‘page 5 205’ so that a horizontal length 245 of ‘page 5 205’ is equal to the horizontal length 235 of the left region 225 as in the drawing illustrated by reference numeral 240 of FIG. 2.

In this way, when the first scale value is calculated by the first scale value calculation unit 115, the size adjustment unit 116 may adjust the size of each of ‘Page 1, Page 2, Page 3, . . . , Page 10’ according to ‘S₁ 255’ which is the first scale value.

In this way, when the size of each of ‘Page 1, Page 2, Page 3, . . . , Page 10’ is adjusted by the size adjustment unit 116, the document display unit 117 may display an n-th page among ‘Page 1, Page 2, Page 3, . . . , Page 10’ at the left region 225, and simultaneously display an n+1-th page at the right region 230.

Assuming that ‘n=5’, the document display unit 117 may display ‘page 5 205’ which is a fifth page among ‘Page 1, Page 2, Page 3, . . . , Page 10’ at the left region 225, and simultaneously display ‘page 6 306’ which is a sixth page at the right region 230 as in the drawing illustrated in FIG. 3.

In this case, the electronic apparatus 110 according to the present invention calculates ‘S₁ 255’ which is the first scale value according to ‘page 5 205’ with the maximum horizontal length, and then adjusts sizes of the remaining pages based on ‘S₁ 255’ which is the first scale value to display the pages at the left region 225 and the right region 230 to process the entire region of each page to be displayed while being included in the left region 225 and the right region 230 without departing from the left region 225 and the right region 230.

In this case, according to an embodiment, the size adjustment unit 116 may include a confirmation unit 118, a second scale value calculation unit 119, and a size additional adjustment unit 120.

After the size of each of the k pages is adjusted according to the first scale value, the confirmation unit 118 additionally confirms a vertical length of the left region and confirms whether there is a page of which vertical length is more than the vertical length of the left region among the k pages of which sizes are adjusted according to the first scale value.

When it is confirmed that the second page is present as the page of which vertical length is more than the vertical length of the left region among the k pages of which sizes are adjusted according to the first scale value, the second scale value calculation unit 119 calculates a second scale value for a case of performing size adjustment of the second page so that the vertical length of the second page is equal to the vertical length of the left region.

The size additional adjustment unit 120 additionally adjusts the size of each of the k pages of which sizes are adjusted according to the first scale value based on the second scale value when the second scale value is calculated.

For example, as in the above-described example, it is assumed that the size of each of ‘Page 1, Page 2, Page 3, . . . , Page 10’ is adjusted according to ‘S₁ 255’ which is the first scale value by the size adjustment unit 116. In this case, the confirmation unit 118 may additionally confirm a vertical length of the left region 225.

Then, the confirmation unit 118 may confirm whether there is a page of which vertical length is more than the vertical length of the left region 225 among ‘Page 1, Page 2, Page 3, . . . , Page 10’ of which sizes are adjusted according to ‘S₁ 255’ which is the first scale value.

In this case, when it is confirmed that ‘page 4’ is present as the page of which vertical length is more than the vertical length of the left region 225 among ‘Page 1, Page 2, Page 3, . . . , Page 10’ of which sizes are adjusted according to ‘S₁ 255’ which is the first scale value, the second scale value calculation unit 119 may calculate, as ‘S₂’, a second scale value for a case of performing size adjustment of ‘page ‘4’ so that the vertical length of ‘page 4’ is equal to the vertical length of the left region 225.

In this way, when the second scale value is calculated by the second scale value calculation unit 119, the size additional adjustment unit 120 may additionally adjust the size of each of ‘Page 1, Page 2, Page 3, . . . , Page 10’ of which sizes are adjusted according to ‘S₁ 255’ which is the first scale value based on ‘S₂’ which is the second scale value.

That is, even though the size of each of the 10 pages is adjusted according to the first scale value, when it is confirmed that there is a predetermined page of which vertical length is more than the vertical length of the left region 225 among the 10 pages, the electronic apparatus 110 may calculate the second scale value based on the vertical length of the corresponding page and the vertical length of the left region 225, and then additionally adjust the size of each of the 10 pages according to the second scale value because the corresponding page may be displayed by departing from the left region 225 or the right region 230.

According to an embodiment of the present invention, the electronic apparatus 110 may further include a page switching unit 121 and a page reverse switching unit 122.

When a page switching instruction to a next page for the electronic document is applied from the user in a situation in which the n-th page is displayed at the left region and the n+1-th page is simultaneously displayed at the right region through the document display unit 117, the page switching unit 121 confirms a size of n, and displays an n+2-th page at the left region and displays an n+3-th page at the right region at the same time when it is confirmed that n is less than k−2, and displays only the n+2-th page at the left region when it is confirmed that n is k−2.

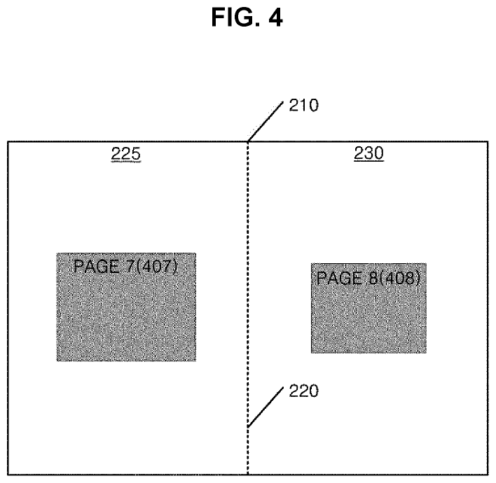

For example, referring to FIGS. 3 and 4, an operation of the page switching unit 121 will be described in detail as an example.

First, as in the drawing illustrated in FIG. 3, it is assumed that there is a situation in which ‘page 5 205’ which is the fifth page is displayed at the left region 225 and ‘page 6 306’ which is the sixth page is displayed at the right region 230 at the same time through the document display unit 117.

In this case, when the page switching instruction to the next page for the electronic document is applied to the electronic apparatus 110 from the user, the page switching unit 121 confirms that the size of n is 5, and then confirms that n is less than 8 to display ‘page 7 407’ which is a seventh page at the left region 225 and ‘page 8 408’ which is an eighth page at the right region 230 at the same time as in the drawing illustrated in FIG. 4.

When it is assumed that there is a situation in which ‘page 8’ which is the eighth page is displayed at the left region 225 and ‘page 9’ which is a ninth page is displayed at the right region 230 at the same time through the document display unit 117, the page switching unit 121 confirms that n is 8 which corresponds to k−2 to display only ‘page 10’ which is a tenth page at the left region 225.

When a page reverse switching instruction to a previous page for the electronic document is applied from the user in a situation in which the n-th page is displayed at the left region and the n+1-th page is simultaneously displayed at the right region through the document display unit 117, the page reverse switching unit 122 confirms the size of n, and displays an n−2-th page at the left region and displays an n−1-th page at the right region at the same time when it is confirmed that n is more than 2, and displays only the n−1-th page at the right region when it is confirmed that n is 2.

For example, as in the drawing illustrated in FIG. 3, it is assumed that there is a situation in which ‘page 5 205’ which is the fifth page is displayed at the left region 225 and page 6 306′ which is the sixth page is displayed at the right region 230 at the same time through the document display unit 117.

In this case, when the page reverse switching instruction to the previous page for the electronic document is applied to the electronic apparatus 110 from the user, the page reverse switching unit 122 confirms that the size of n is 5, and then confirms that n is more than 2 to display ‘page 3’ which is a third page at the left region 225 and ‘page 4’ which is a fourth page at the right region 230 at the same time.

When it is assumed that there is a situation in which ‘page 2’ which is the second page is displayed at the left region 225 and ‘page 3’ which is the third page is displayed at the right region 230 at the same time through the document display unit 117, the page reverse switching unit 122 confirms that n is 2 to display only ‘page 1’ which is the first page at the right region 230.

According to an embodiment of the present invention, the page switching unit 121 and the page reverse switching unit 122 may apply a predetermined page switching animation effect when switching a predetermined page to the next page or the previous page. For example, the page switching unit 121 and the page reverse switching unit 122 may display the page on the screen by applying the page switching animation effect as if a paper book is switched when the page is switched.

According to an embodiment of the present invention, when the page switching unit 121 confirms that n is more than k−2 according to a result of confirming the size of n in order to perform page switching according to the page switching instruction applied from the user, the page switch 121 may generate a first guidance message indicating that there is no next page for the electronic document, and then display the first guidance message on the screen.

For example, when it is assumed that ‘n=9’ and ‘k=10’, the page switching unit 121 confirms that the size of n is more than 8 to generate the first guidance message indicating that there is no next page for the electronic document, and then display the first guidance message on the screen.

Further, according to an embodiment of the present invention, when the page reverse switching unit 122 confirms that n is less than 2 according to the result of confirming the size of n in order to perform page reverse switching according to the page reverse switching instruction applied from the user, the page reverse switching unit 122 may generate a second guidance message indicating that there is no previous page for the electronic document, and then display the second guidance message on the screen.

For example, when it is assumed that ‘n=1’ and ‘k=10’, the page reverse switching unit 122 confirms that the size of n is more than 2 to generate the second guidance message indicating that there is no previous page for the electronic document, and then display the second guidance message on the screen.

According to an embodiment of the present invention, the electronic apparatus 110 may further include a word extraction unit 123, an appearance frequency confirmation unit 124, a page feature vector generation unit 125, a vector similarity calculation unit 126, a selection unit 127, an overlap display unit 128, and a removal display unit 129.

When a similar page search instruction for the n-th page is applied from the user in a situation in which the n-th page is displayed at the left region and the n+1-th page is displayed at the right region at the same time through the document display unit 117, the word extraction unit 123 extracts t (t is a natural number of 2 or more) words in an order of increasing an appearance frequency in the electronic document from the electronic document.

The appearance frequency confirmation unit 124 confirms an appearance frequency of each of the t words in each of the k pages.

The page feature vector generation unit 125 configures a t-dimensional vector having the appearance frequency of each of the t words in each page as a component with respect to each of the k pages to generate a t-dimensional page feature vector corresponding to each of the k pages.

The vector similarity calculation unit 126 calculates a vector similarity between a page feature vector of the n-th page and page feature vectors of the remaining pages other than the n-th page among the k pages.

Here, the vector similarity between the page feature vector of the n-th page and the page feature vectors of the remaining pages may be calculated according to Equation 1 below.

$$M = S \frac{1}{( 1 + D )} \qquad [ Equation 1 ]$$

Where M means a vector similarity between both vectors, S means a cosine similarity between both vectors, D means a Euclidean distance between both vectors, and the cosine similarity S between both vectors and the Euclidean distance D between both vectors may be calculated according to Equation 2 below and Equation 3 below.

$$S = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}} \qquad [ Equation 2 ]$$

Where S as a cosine similarity between vectors A and B has a value between −1 and 1, and a larger value of S means that both vectors are similar vectors, and Aᵢ means an i-th component of vector A and B; means an i-th component of vector B.

$$D = \sqrt{{\sum }_{i = 1}^{n} {( {A}_{i} - {B}_{i} )}^{2}} \qquad [ Equation 3 ]$$

In Equation 3 above, D represents the Euclidean distance, and Aᵢ and B; represent i-th components included in both vectors. In general, as the Euclidean distance between both vectors is the smaller, the both vectors are regarded as similar vectors, and as the Euclidean distance between the both vectors is the larger, the both vectors may be regarded to as non-similar vectors.

The selection unit 127 selects a third page having a page feature vector having a maximum vector similarity to the page feature vector of the n-th page, among the remaining pages.

The overlap display unit 128 displays the third page by overlapping the third page with an upper layer of the n+1-th page displayed at the right region when the third page is selected.

When the third page is displayed while being overlapped with the upper layer of the n+1-th page displayed at the right region, and then a page removal instruction for the third page is applied from the user, the removal display unit 129 removes the third page displayed while being overlapped with the upper layer of the n+1-th page at the right region to process only the n+1-th page to be displayed at the right region.

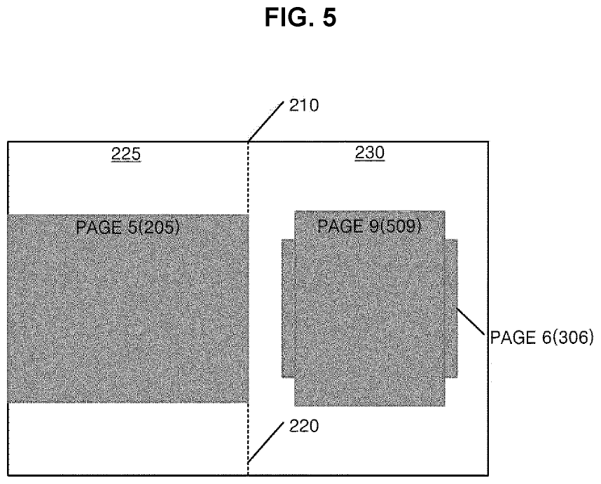

Hereinafter, referring to FIGS. 3 and 5 operations of the word extraction unit 123, the appearance frequency confirmation unit 124, the page feature vector generation unit 125, the vector similarity calculation unit 126, the selection unit 127, the overlap display unit 128, and the removal display unit 129 will be described in detail as an example.

First, as in the drawing illustrated in FIG. 3, it is assumed that there is a situation in which ‘page 5 205’ which is the fifth page is displayed at the left region 225 and ‘page 6 306’ which is the sixth page is displayed at the right region 230 at the same time through the document display unit 117.

In this case, when the similar page search instruction for ‘page 5 205’ which is the fifth page is applied to the electronic apparatus 110 from the user, the word extraction unit 123 may extract t words from the electronic document in the order of increasing the appearance frequency in the electronic document.

When it is assumed that ‘t=5’, and ‘intellectual property rights, patents, copyrights, registration, and rejection’ which are five words are extracted from the electronic document in the order of increasing the appearance frequency in the electronic document by the word extraction unit 123, the appearance frequency confirmation unit 124 may confirm an appearance frequency at which each of ‘intellectual property rights, patents, copyrights, registration, and rejection’ which are the five words in each of ‘page 1, page 2, page 3, page 4, page 5 205, . . . , page 9 509, page 10’ which are the 10 pages appears.

At this time, it is assumed that the appearance frequency confirmation unit 124 confirms that appearance frequencies of ‘intellectual property rights, patents, copyrights, registration, and rejection’ in ‘Page 1, Page 2, Page 3, Page 4, Page 5 205, . . . , Page 9 509, and Page 10’, respectively are ‘0 (times), 0 (times), 1 (times), 0 (times), 0 (times)’, ‘1 (times), 0 (times), 0 (times), 0 (times), 0 (times)’, ‘0 (times), 0 (times), 1 (times), 1 (times), 0 (times)’, ‘1 (times), 0 (times), 1 (times), 0 (times), 0 (times)’, ‘0 (times), 6 (times), 0 (times), 4 (times), 5 (times)’, . . . , ‘0 (times), 5 (times), 0 (times), 4 (times), 4 (times)’, ‘0 (times), 0 (times), 0 (times), 0 (times), 0 (times)’.

In this case, the page feature vector generation unit 125 configures a 5-dimensional vector having the appearance frequency at which each of ‘intellectual property rights, patents, copyrights, registration, and rejection’ appears in each page as the component with respect to each of ‘Page 1, Page 2, Page 3, Page 4, Page 5 205, . . . , Page 9 509, and Page 10’ to generate a 5-dimensional page feature vector corresponding to each of ‘Page 1, Page 2, Page 3, Page 4, Page 5 205, . . . , Page 9 509, and Page 10’.

In this regard, since appearance frequencies at which ‘intellectual property rights, patents, copyrights, registration, and rejection’ appear, respectively for ‘page 1’ are ‘0 (times), 0 (times), 1 (times), 0 (times), 0 (times)’, the page feature vector generation unit 125 may generate ‘[0 0 1 0 0]’ as a 5-dimensional page feature vector for ‘page 1’. By such a scheme, the page feature vector generation unit 125 may generate ‘[0 0 1 0 0], [1 0 0 0 0], [0 0 1 1 0], [1 0 1 0 0], [0 6 0 4 5], . . . , [0 5 0 4 4], [0 0 0 0 0]’ as 5-dimensional page feature vectors corresponding to ‘Page 1, Page 2, Page 3, Page 4, Page 5 205, . . . , Page 9 509, and Page 10’, respectively.

In this way, when the page feature vectors are generated, which correspond to ‘Page 1, Page 2, Page 3, Page 4, Page 5 205, . . . , Page 9 509, and Page 10’, respectively, the vector similarity calculation unit 126 may calculate vectors similarities between ‘[0 6 0 4 5]’ which is the page feature vector which is ‘page 5205’ and ‘[0 0 1 0 0], [1 0 0 0 0], [0 0 1 1, 0][1 0 1 0 0], . . . , [0 5 0 4 4], [0 0 0 0 0]’ which are the page feature vectors of ‘Page 1, Page 2, Page 3, Page 4, . . . , Page 9 509, and Page 10’ which are the remaining pages other than page 5 205′ among ‘Page 1, Page 2, Page 3, Page 4, Page 5 205, . . . , Page 9 509, and Page 10’ as ‘M₁, M₂, M₃, M₄, . . . , M₈, M₉’ according to Equation 1 to Equation 3 above.

When it is assumed that a vector similarity ‘M₈’ is calculated to be the maximum among the vector similarities calculated with respect to the remaining pages, respectively, the selection unit 127 may select ‘page 9 509’ as the third page having the page feature vector maximum vector similarity to the page feature vector ‘page 5 205’ among ‘Page 1, Page 2, Page 3, Page 4, . . . , Page 9 509, and Page 10’ which are the remaining pages.

In this way, when the third page is selected by the selection unit 127, the overlap display unit 128 may display ‘page 9 509’ which is the third page to be overlapped with an upper layer of ‘page 6 306 which is the sixth page displayed at the right region 230 as in the drawing illustrated in FIG. 5.

In this way, as in the drawing illustrated in FIG. 5, when a page removal instruction for ‘page 9 509’ is applied to the electronic apparatus 110 from the user after ‘page 9 509’ is displayed to be overlapped with the upper layer of ‘page 6 306’ displayed at the right region 230 by the overlap display unit 128, the removal display unit 129 removes ‘page 9 509’ displayed to be overlapped with the upper layer of ‘page 6 306’ at the right region 230 to process only ‘page 6 306’ to be displayed at the right region 230 again.

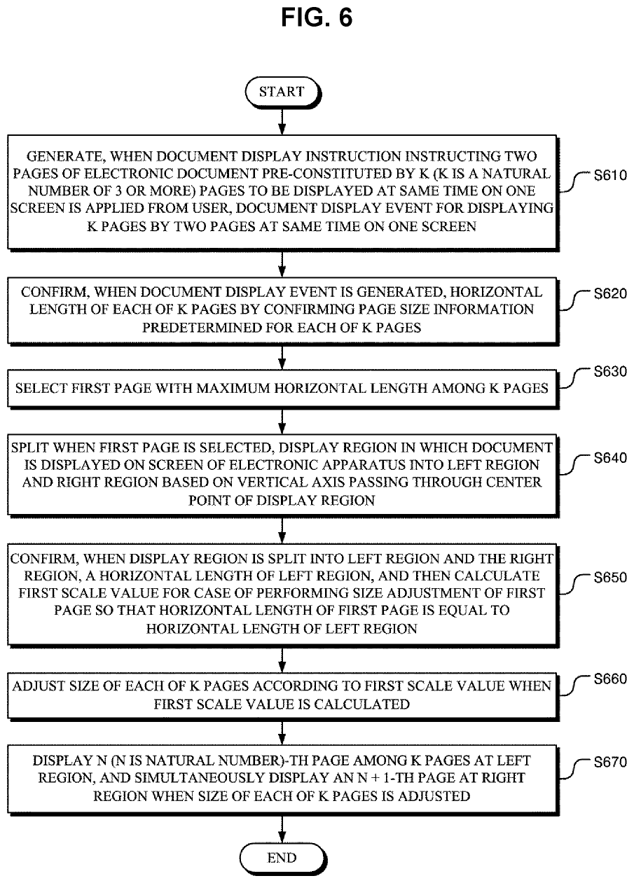

FIG. 6 is a flowchart illustrating an operating method of an electronic apparatus capable of displaying the page that constitutes an electronic document by two pages at the same time on one screen according to an embodiment of the present invention.

In step S610, when a document display instruction instructing two pages of an electronic document pre-constituted by k (k is a natural number of 3 or more) pages to be displayed at the same time on one screen is applied from the user, a document display event for displaying the k pages by two pages at the same time on one screen is generated.

In step S620, when the document display event is generated, a horizontal length of each of the k pages is confirmed by confirming page size information predetermined for each of the k pages.

In step S630, a first page with a maximum horizontal length is selected among the k pages.

In step S640, when the first page is selected, a display region in which a document is displayed on a screen of the electronic apparatus is split into a left region and a right region based on a vertical axis passing through a center point of the display region.

In step S650, when the display region is split into the left region and the right region, a horizontal length of the left region is confirmed, and then a first scale value for a case of performing size adjustment of the first page so that the horizontal length of the first page is equal to the horizontal length of the left region is calculated.

In step S660, a size of each of the k pages is adjusted according to the first scale value when the first scale value is calculated.

In step S670, an n (n is a natural number)-th page is displayed among the k pages at the left region, and simultaneously, an n+1-th page is displayed at the right region when the size of each of the k pages is adjusted.

In this case, according to an embodiment of the present invention, the operating method may include additionally confirming, after the size of each of the k pages is adjusted according to the first scale value step S660, a vertical length of the left region and confirming whether there is a page of which vertical length is more than the vertical length of the left region among the k pages of which sizes are adjusted according to the first scale value, calculating, when it is confirmed that the second page is present as the page of which vertical length is more than the vertical length of the left region among the k pages of which sizes are adjusted according to the first scale value, a second scale value for a case of performing size adjustment of the second page so that the vertical length of the second page is equal to the vertical length of the left region, and additionally adjusting the size of each of the k pages of which sizes are adjusted according to the first scale value based on the second scale value when the second scale value is calculated.

Further, according to an embodiment of the present invention, the operating method of the electronic apparatus may further include confirming, when a page switching instruction to a next page for the electronic document is applied from the user in a situation in which the n-th page is displayed at the left region and the n+1-th page is simultaneously displayed at the right region, a size of n, and displaying an n+2-th page at the left region and displays an n+3-th page at the right region at the same time when it is confirmed that n is less than k−2, and displaying only the n+2-th page at the left region when it is confirmed that n is k−2, and confirming, when a page reverse switching instruction to a previous page for the electronic document is applied from the user in a situation in which the n-th page is displayed at the left region and the n+1-th page is simultaneously displayed at the right region, the size of n, and displays an n−2-th page at the left region and displaying an n−1-th page at the right region at the same time when it is confirmed that n is more than 2, and displaying only the n−1-th page at the right region when it is confirmed that n is 2.

In this case, according to an embodiment of the present invention, in the displaying of only the n+2-th page when it is confirmed that n is more than k−2 according to a result of confirming the size of n, a first guidance message indicating that there is no next page for the electronic document may be generated, and then the first guidance message may be displayed on the screen.

In this case, in the displaying of only the n−1-th page, when it is confirmed that n is less than 2 according to a result of confirming the size of n, a second guidance message indicating that there is no previous page for the electronic document may be generated, and then second guidance message may be displayed on the screen.

Further, according to an embodiment of the present invention, the operating method of the electronic apparatus may further include extracting, when a similar page search instruction for the n-th page is applied from the user in a situation in which the n-th page is displayed at the left region and the n+1-th page is displayed at the right region at the same time, t (t is a natural number of 2 or more) words in an order of increasing an appearance frequency in the electronic document from the electronic document, confirming an appearance frequency of each of the t words in each of the k pages, configuring a t-dimensional vector having the appearance frequency of each of the t words in each page as a component with respect to each of the k pages to generate a t-dimensional page feature vector corresponding to each of the k pages, calculating a vector similarity between a page feature vector of the n-th page and page feature vectors of the remaining pages other than the n-th page among the k pages, selecting a third page having a page feature vector having a maximum vector similarity to the page feature vector of the n-th page, among the remaining pages, displays the third page by overlapping the third page with an upper layer of the n+1-th page displayed at the right region when the third page is selected, and when the third page is displayed while being overlapped with the upper layer of the n+1-th page displayed at the right region, and then a page removal instruction for the third page is applied from the user, removing the third page displayed while being overlapped with the upper layer of the n+1-th page at the right region to process only the n+1-th page to be displayed at the right region.

Hereinabove, the operating method of the electronic apparatus according to an embodiment of the present invention is described with reference to FIG. 6. Here, since the operating method of the electronic apparatus according to an embodiment of the present invention may correspond to the configuration of the operation of the electronic apparatus 110 described by using FIGS. 1 to 5, a more detailed description thereof will be omitted.

The operating method of the electronic apparatus capable of displaying the page that constitutes an electronic document by two pages at the same time on one screen according to an embodiment of the present invention may be implemented by a computer program stored in a storage medium for executing the computer program through coupling with a computer.

Further, the operating method of the electronic apparatus capable of displaying the page that constitutes an electronic document by two pages at the same time on one screen according to an embodiment of the present invention may be implemented as a computer program instruction for executing the computer program through coupling with a computer and recorded in a computer readable medium. The computer readable medium may include a program command, a data file, a data structure, etc., singly or combinationally. The program command recorded in the medium may be specially designed and configured for the present invention, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present invention has been described by specified matters such as detailed components, and the like and limited exemplary embodiments and drawings, but the description is just provided to assist more overall understanding of the present invention and the present invention is not limited to the exemplary embodiment and various modifications and changes can be made by those skilled in the art from such a disclosure.

Accordingly, the spirit of the present invention should not be defined only by the described exemplary embodiments, and it should be appreciated that claims to be described below and all things which are equivalent to the claims or equivalently modified to the claims are included in the scope of the spirit of the present invention.

1. An electronic apparatus capable of displaying the page that constitutes an electronic document by two pages at the same time on one screen, the electronic apparatus comprising:
a document display event generation unit generating, when a document display instruction instructing two pages of an electronic document pre-constituted by k, wherein k is a natural number of 3 or more, pages to be displayed at the same time on one screen is applied from the user, a document display event for displaying the k pages by two pages at the same time on one screen;
a horizontal length confirmation unit confirming, when the document display event is generated, a horizontal length of each of the k pages by confirming page size information predetermined for each of the k pages;
a page selection unit selecting the first page with a maximum horizontal length among the k pages;
a region split unit splitting, when the first page is selected, a display region in which a document is displayed on a screen of the electronic apparatus into a left region and a right region based on a vertical axis passing through a center point of the display region;
a first scale value calculation unit confirming, when the display region is split into the left region and the right region, a horizontal length of the left region, and then calculating a first scale value for a case of performing size adjustment of the first page so that the horizontal length of the first page is equal to the horizontal length of the left region;
a size adjustment unit adjusting a size of each of the k pages according to the first scale value when the first scale value is calculated; and
a document display unit displaying an n-th, wherein n is a natural number, page among the k pages at the left region, and simultaneously displays an n+1-th page at the right region when the size of each of the k pages is adjusted.

2. The electronic apparatus of claim 1, wherein the size adjustment unit includes
a confirmation unit additionally confirming, after the size of each of the k pages is adjusted according to the first scale value, a vertical length of the left region and confirming whether there is a page of which vertical length is more than the vertical length of the left region among the k pages of which sizes are adjusted according to the first scale value,
a second scale value calculation unit calculating, when it is confirmed that the second page is present as the page of which vertical length is more than the vertical length of the left region among the k pages of which sizes are adjusted according to the first scale value, a second scale value for a case of performing size adjustment of the second page so that the vertical length of the second page is equal to the vertical length of the left region, and
a size additional adjustment unit additionally adjusting the size of each of the k pages of which sizes are adjusted according to the first scale value based on the second scale value when the second scale value is calculated.

3. The electronic apparatus of claim 1, further comprising:
when a page switching instruction to a next page for the electronic document is applied from the user in a situation in which the n-th page is displayed at the left region and the n+1-th page is simultaneously displayed at the right region through the document display unit, a page switching unit confirming a size of n, and displaying an n+2-th page at the left region and displays an n+3-th page at the right region at the same time when it is confirmed that n is less than k−2, and displays only the n+2-th page at the left region when it is confirmed that n is k−2, and
when a page reverse switching instruction to a previous page for the electronic document is applied from the user in a situation in which the n-th page is displayed at the left region and the n+1-th page is simultaneously displayed at the right region through the document display unit, a page reverse switching unit confirming the size of n, and displays an n−2-th page at the left region and displays an n−1-th page at the right region at the same time when it is confirmed that n is more than 2, and displaying only the n−1-th page at the right region when it is confirmed that n is 2.

4. The electronic apparatus of claim 3, wherein when it is confirmed that n is more than k−2 according to a result of confirming the size of n, the page switching unit generates a first guidance message indicating that there is no next page for the electronic document, and then displays the first guidance message on the screen, and
when it is confirmed that n is less than 2 according to a result of confirming the size of n, the page reverse switching unit generates a second guidance message indicating that there is no previous page for the electronic document, and then displays the second guidance message on the screen.

5. The electronic apparatus of claim 1, further comprising:
when a similar page search instruction for the n-th page is applied from the user in a situation in which the n-th page is displayed at the left region and the n+1-th page is displayed at the right region at the same time through the document display unit, a word extraction unit extracting t, wherein t is a natural number of 2 or more, words in an order of increasing an appearance frequency in the electronic document from the electronic document,
an appearance frequency confirmation unit confirming an appearance frequency of each of the t words in each of the k pages,
a page feature vector generation unit configuring a t-dimensional vector having the appearance frequency of each of the t words in each page as a component with respect to each of the k pages to generate a t-dimensional page feature vector corresponding to each of the k pages,
a vector similarity calculation unit calculating a vector similarity between a page feature vector of the n-th page and page feature vectors of the remaining pages other than the n-th page among the k pages,
a selection unit selecting a third page having a page feature vector having a maximum vector similarity to the page feature vector of the n-th page, among the remaining pages,
an overlap display unit displaying the third page by overlapping the third page with an upper layer of the n+1-th page displayed at the right region when the third page is selected, and
when the third page is displayed while being overlapped with the upper layer of the n+1-th page displayed at the right region, and then a page removal instruction for the third page is applied from the user, a removal display unit removing the third page displayed while being overlapped with the upper layer of the n+1-th page at the right region to process only the n+1-th page to be displayed at the right region.

6. An operating method of an electronic apparatus capable of displaying the page that constitutes an electronic document by two pages at the same time on one screen, the operating method comprising:
generating, when a document display instruction instructing two pages of an electronic document pre-constituted by k, wherein k is a natural number of 3 or more, pages to be displayed at the same time on one screen is applied from the user, a document display event for displaying the k pages by two pages at the same time on one screen;
confirming, when the document display event is generated, a horizontal length of each of the k pages by confirming page size information predetermined for each of the k pages;
selecting the first page with a maximum horizontal length among the k pages;
splitting, when the first page is selected, a display region in which a document is displayed on a screen of the electronic apparatus into a left region and a right region based on a vertical axis passing through a center point of the display region;
confirming, when the display region is split into the left region and the right region, a horizontal length of the left region, and then calculating a first scale value for a case of performing size adjustment of the first page so that the horizontal length of the first page is equal to the horizontal length of the left region;
adjusting a size of each of the k pages according to the first scale value when the first scale value is calculated; and
displaying an n-th, wherein n is a natural number, page among the k pages at the left region, and simultaneously displaying an n+1-th page at the right region when the size of each of the k pages is adjusted.

7. The operating method of claim 6, wherein the adjusting of the size includes
additionally confirming, after the size of each of the k pages is adjusted according to the first scale value, a vertical length of the left region and confirming whether there is a page of which vertical length is more than the vertical length of the left region among the k pages of which sizes are adjusted according to the first scale value,
calculating, when it is confirmed that the second page is present as the page of which vertical length is more than the vertical length of the left region among the k pages of which sizes are adjusted according to the first scale value, a second scale value for a case of performing size adjustment of the second page so that the vertical length of the second page is equal to the vertical length of the left region, and
additionally adjusting the size of each of the k pages of which sizes are adjusted according to the first scale value based on the second scale value when the second scale value is calculated.

8. The operating method of claim 6, further comprising:
when a page switching instruction to a next page for the electronic document is applied from the user in a situation in which the n-th page is displayed at the left region and the n+1-th page is simultaneously displayed at the right region, confirming a size of n, and displaying an n+2-th page at the left region and displays an n+3-th page at the right region at the same time when it is confirmed that n is less than k−2, and displays only the n+2-th page at the left region when it is confirmed that n is k−2; and
when a page reverse switching instruction to a previous page for the electronic document is applied from the user in a situation in which the n-th page is displayed at the left region and the n+1-th page is simultaneously displayed at the right region, confirming the size of n, and displays an n−2-th page at the left region and displays an n−1-th page at the right region at the same time when it is confirmed that n is more than 2, and displaying only the n−1-th page at the right region when it is confirmed that n is 2.

9. The operating method of claim 8, wherein as the page switching instruction is applied from the user, when it is confirmed that n is more than k−2 according to a result of confirming the size of n, a first guidance message indicating that there is no next page for the electronic document is generated, and then the first guidance message is displayed on the screen, and
as the page reverse switching instruction is applied from the user, when it is confirmed that n is less than 2 according to a result of confirming the size of n, a second guidance message indicating that there is no previous page for the electronic document is generated, and then second guidance message is displayed on the screen.

10. The operating method of claim 6, further comprising:
when a similar page search instruction for the n-th page is applied from the user in a situation in which the n-th page is displayed at the left region and the n+1-th page is displayed at the right region at the same time, extracting t, wherein t is a natural number of 2 or more, words in an order of increasing an appearance frequency in the electronic document from the electronic document;
confirming an appearance frequency of each of the t words in each of the k pages;
configuring a t-dimensional vector having the appearance frequency of each of the t words in each page as a component with respect to each of the k pages to generate a t-dimensional page feature vector corresponding to each of the k pages;
calculating a vector similarity between a page feature vector of the n-th page and page feature vectors of the remaining pages other than the n-th page among the k pages;
selecting a third page having a page feature vector having a maximum vector similarity to the page feature vector of the n-th page, among the remaining pages;
displaying the third page by overlapping the third page with an upper layer of the n+1-th page displayed at the right region when the third page is selected; and
when the third page is displayed while being overlapped with the upper layer of the n+1-th page displayed at the right region, and then a page removal instruction for the third page is applied from the user, removing the third page displayed while being overlapped with the upper layer of the n+1-th page at the right region to process only the n+1-th page to be displayed at the right region.

11-12. (canceled)

13. A non-transitory computer readable recording medium having a program recorded therein for allowing a computer to execute an operating method of an electronic apparatus capable of displaying the page that constitutes an electronic document by two pages at the same time on one screen, the operating method comprising:
generating, when a document display instruction instructing two pages of an electronic document pre-constituted by k, wherein k is a natural number of 3 or more, pages to be displayed at the same time on one screen is applied from the user, a document display event for displaying the k pages by two pages at the same time on one screen;
confirming, when the document display event is generated, a horizontal length of each of the k pages by confirming page size information predetermined for each of the k pages;
selecting the first page with a maximum horizontal length among the k pages;
splitting, when the first page is selected, a display region in which a document is displayed on a screen of the electronic apparatus into a left region and a right region based on a vertical axis passing through a center point of the display region;
confirming, when the display region is split into the left region and the right region, a horizontal length of the left region, and then calculating a first scale value for a case of performing size adjustment of the first page so that the horizontal length of the first page is equal to the horizontal length of the left region;
adjusting a size of each of the k pages according to the first scale value when the first scale value is calculated; and
displaying an n-th, wherein n is a natural number, page among the k pages at the left region, and simultaneously displaying an n+1-th page at the right region when the size of each of the k pages is adjusted.
